(19) United States
(12) Patent Application Publication
(10) Pub. No.: US 2023/0206630 A1
(43) Pub. Date: Jun. 29, 2023

(54) INFORMATION PROCESSING DEVICE, CONTROL METHOD AND STORAGE MEDIUM

(71) Applicant: NEC Corporation, Minato-ku, Tokyo (JP)

(72) Inventors: Haruna WATANABE, Tokyo (JP); Katsumi KIKUCHI, Tokyo (JP); Soma SHIRAISHI, Tokyo (JP); Yu NABETO, Tokyo (JP)

(73) Assignee: NEC Corporation, Minato-ku, Tokyo (JP)

(21) Appl. No.: 17/926,726

(22) PCT Filed: May 26, 2020
(86) PCT No.: PCT/JP2020/020770

§ 371 Date: Nov. 21, 2022

(51) Int. Cl. G06V 20/40; G06V 10/776; G06V 10/774; G06V 10/82

(52) U.S. Cl. CPC G06V 20/41; G06V 10/776; G06V 10/774; G06V 10/82

(57) ABSTRACT

The information processing device 1X mainly includes an input data acquisition means 14X, an importance degree calculation means 15X, and an attention part identification means 16X. The input data acquisition means 14X is configured to acquire input data “Di” including at least one of video data or audio data. The importance degree calculation means 15X is configured to calculate a degree of importance of the input data Di. The attention part identification means 16X is configured to identify an attention part of the input data Di in a calculation of the degree of importance.

### TECHNICAL FIELD

The present disclosure relates to an information processing device, a control method, and a recording medium for performing a process related to generating of a digest.

### BACKGROUND ART

There are technologies which generate a digest by editing video data that is raw material data. For example, Patent Literature 1 discloses a method for manufacturing the digest by confirming highlight scenes from a video stream of a sports event at a ground. Further, Non-Patent Literature 1 discloses information relating to a Grad-CAM (Gradient-weighted Class Activation Mapping) which is a technique of visualizing a basis for determination by a convolution neural network.

### PRIOR ART DOCUMENTS

### Patent Literature

Patent Literature 1: JP 2019-522948A

### NON-PATENT LITERATURE

Non-Patent Literature 1: Ramprasaath R. Selvaraju, Michael Cogswell, Abhishek Das, Ramakrishna Vedantam, Devi Parikh, Dhruv Batra, Grad-CAM: Visual Explanations from Deep Networks via Gradient-based Localization, [Search on Apr. 27, 2020], Internet <URL: https://arxiv.org/pdf/1610.02391.pdf>

### SUMMARY

### Problem to be Solved by the Invention

When the degree of importance is calculated for video data which is raw material data and the digest generation is carried out based on the degree of importance, it is required that the accuracy of the model for calculating the degree of importance is sufficiently high. Therefore, in such a case, it is necessary to appropriately evaluate whether or not the model for calculating the degree of importance has sufficient accuracy.

In view of the above-described issue, it is therefore an example object of the present disclosure to provide an information processing device, a control method, and a storage medium capable of acquiring information suitable for evaluation of a model for calculating the degree of importance used in digest generation.

### Means for Solving the Problem

In one mode of the information processing device, there is provided an information processing device including: an input data acquisition means configured to acquire input data including at least one of video data or audio data; an importance degree calculation means configured to calculate a degree of importance of the input data; and an attention part identification means configured to identify an attention part of the input data in a calculation of the degree of importance.

In one mode of the control method, there is provided a control method executed by a computer, the control method including: acquiring input data including at least one of video data or audio data; calculating a degree of importance of the input data; and identifying an attention part of the input data in a calculation of the degree of importance.

In one mode of the storage medium, there is provided a storage medium storing a program executed by a computer, the program causing the computer to function as: an input data acquisition means configured to acquire input data including at least one of video data or audio data; an importance degree calculation means configured to calculate a degree of importance of the input data; and an attention part identification means configured to identify an attention part of the input data in a calculation of the degree of importance.

### Effect of the Invention

An example advantage according to the present invention is to suitably specify a portion noted in the calculation of the degree of importance used in the digest generation.

### BRIEF DESCRIPTION OF THE DRAWINGS

FIG. 1 illustrates a configuration of an attention part visualization system in a first example embodiment.

FIG. 2 illustrates a hardware configuration of an information processing device.

FIG. 3 is an example of a functional block of the information processing device.

FIG. 4A illustrates an attention part in the case where sample data inputted to an importance degree inference engine is configured by a single image per time.

FIG. 4B is a first example of the attention part in the case where sample data inputted to an importance degree inference engine is configured by plural images per time.

FIG. 4C is a second example of the attention part in the case where sample data inputted to an importance degree inference engine is configured by plural images per time.

FIG. 5 is a schematic configuration diagram of a system for generating importance degree inference engine information.

FIG. 6 is a first display example of a learning accuracy evaluation view.

FIG. 7 is a second display example of the learning accuracy evaluation view.

FIG. 8 is an example of a flowchart showing the procedure of the attention part visualization process performed by the information processing device in the first example embodiment.

FIG. 9 is an example of a functional block diagram of the information processing device according to a modification.

FIG. 10 is a third display example of the learning accuracy evaluation view.

FIG. 11 is a fourth display example of the learning accuracy evaluation view.

FIG. 12 is a fifth display example of the learning accuracy evaluation view.

FIG. 13 illustrates the configuration of the attention part visualization system in a modification.

FIG. 14 is a functional block diagram of the information processing device according to a second example embodiment.

FIG. 15 is an example of a flowchart executed by the information processing device in the second example embodiment.

### EXAMPLE EMBODIMENTS

Hereinafter, an example embodiment of an information processing device, a control method, and a storage medium will be described with reference to the drawings.

### First Example Embodiment

(1) System Configuration

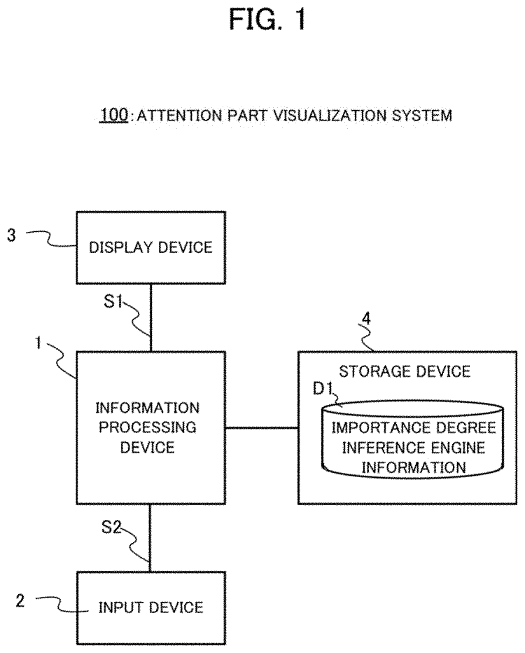

FIG. 1 shows the configuration of an attention part visualization system 100 according to the first example embodiment. The attention part visualization system 100 is a system for visualizing an area (simply referred to as “attention part”) noted in generating edited data (so-called digest) obtained by editing video data (which may include audio data. The same shall apply hereinafter). The attention part visualization system 100 mainly includes an information processing device 1, an input device 2, a display device 3, and a storage device 4. Hereafter, the data to be edited in the generation of the digest is also referred to as “raw material data”.

The information processing device 1 performs data communication with the input device 2 and the display device 3 through a communication network or through a wired or wireless direct communication. Further, when raw material data (also referred to as “input data Di”) to be the target of visualization of the attention part is inputted, the information processing device 1 identifies the attention part noted in the digest generation of the input data Di. The input data Di may be any raw material data stored in the storage device 4 or may be raw material data supplied to the information processing device 1 from an external device other than the storage device 4. Then, the information processing device 1 displays the information on the identified attention part on the display device 3. In this case, the information processing device 1 generates a display signal “S1” for displaying information relating to the identified attention part, and supplies the generated display signal S1 to the display device 3.

The input device 2 is any user interface configured to accept a user input, and examples of the input device 2 include a button, a keyboard, a mouse, a touch panel, and a voice input device. The input device 2 supplies the input signal “S2” generated based on the user input to the information processing device 1. The display device 3 is, for example, a display, a projector or the like, and displays predetermined information based on the display signal S1 supplied from the information processing device 1.

The storage device 4 is a memory configured to store various kinds of information necessary for the process by the information processing device 1. The storage device 4 stores, for example, the importance degree inference engine information D1. The importance degree inference engine information D1 includes parameters of an inference engine (also referred to as “importance degree inference engine”) learned to infer the degree of importance of the video data if the video data is inputted thereto. The degree of importance described above serves as an index of a criterion for determining whether or not each section constituting the input data Di is an important section or a non-important section in the generation of the digest. The learning model of the importance degree inference engine may be a learning model based on any machine learning such as a neural network and a support vector machine. For example, if the model of the importance degree inference engine described above is a neural network such as a convolutional neural network, the importance degree inference engine information D1 includes various parameters regarding the layer structure, the neuron structure of each layer, the number of filters and filter sizes in each layer, and weights for each element of each filter. In addition, the storage device 4 may store raw material data, for generation of the digest, from which the input data Di is to be selected.

The storage device 4 may be an external storage device such as a hard disk connected to or built in to the information processing device 1, or may be a storage medium such as a flash memory. The storage device 4 may be a server device configured to perform data communication with the information processing device 1. The storage device 4 may include a plurality of devices.

The configuration of the attention part visualization system 100 shown in FIG. 1 is an example, and various changes may be applied to the configuration. For example, the input device 2 and the display device 3 may be configured integrally. In this case, the input device 2 and the display device 3 may be configured as a tablet type terminal integral with the information processing device 1. Further, the information processing device 1 may be configured by a plurality of devices. In this case, a plurality of devices constituting the information processing device 1 perform the transmission and reception of information necessary for executing the pre-allocated process among the plurality of devices.

(2) Hardware Configuration of Information Processing Device

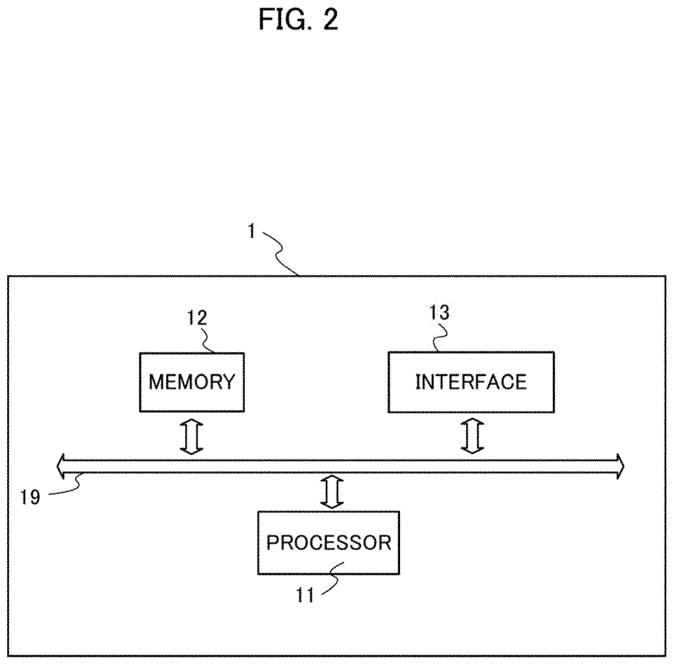

FIG. 2 shows the hardware configuration of the information processing device 1. The information processing device 1 includes a processor 11, a memory 12, and an interface 13 as hardware. The processor 11, the memory 12, and the interface 13 are connected via a data bus 19.

The processor 11 executes a predetermined process by executing a program stored in the memory 12. The processor 11 is one or more processors such as a CPU (Central Processing Unit), GPU (Graphics Processing Unit), and a quantum processor.

The memory 12 is configured by various volatile and non-volatile memories such as RAM (Random Access Memory), ROM (Read Only Memory), and the like. In addition, a program executed by the information processing device 1 is stored in the memory 12. The memory 12 is used as a work memory and temporarily stores information acquired from the storage device 4. The memory 12 may function as a storage device 4. Similarly, the storage device 4 may function as a memory 12 of the information processing device 1. The program executed by the information processing device 1 may be stored in a storage medium other than the memory 12.

The interface 13 is an interface for electrically connecting the information processing device 1 to other devices. For example, the interface for connecting the information processing device 1 to other devices may be a communication interface such as a network adapter for performing transmission and reception of data to and from other devices by wired or wireless communication under the control of the processor 11. In other examples, the information processing device 1 may be connected to other devices by a cable or the like. In this instance, the interface 13 includes a hardware interface compliant with USB (Universal Serial Bus), SATA (Serial AT Attachment), and the like for exchanging data with other devices.

The hardware configuration of the information processing device 1 is not limited to the configuration shown in FIG. 2. For example, the information processing device 1 may include at least one of an input device 2 or a display device 3. Further, the information processing device 1 may be connected to or built in a sound output device such as a speaker.

(3) Functional Block

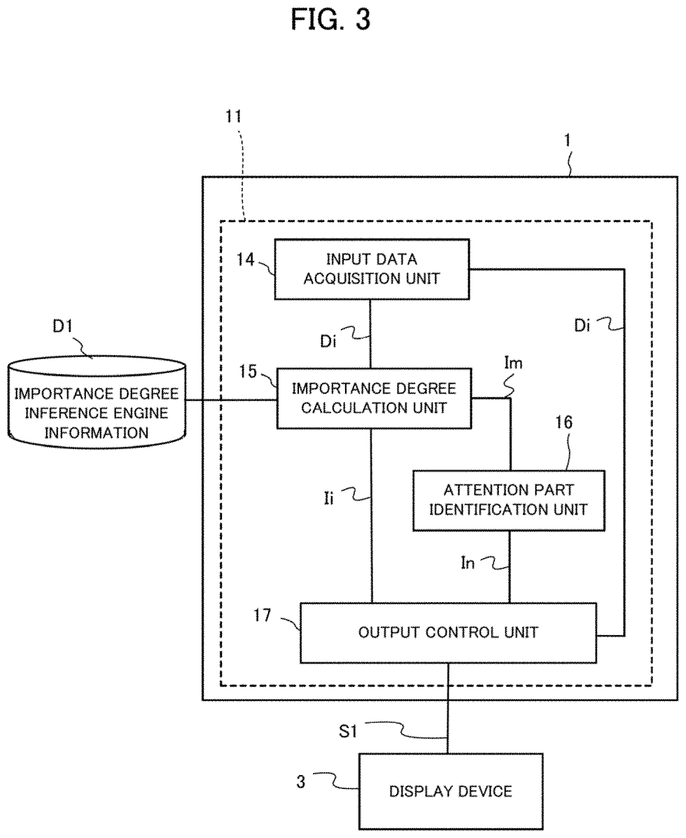

FIG. 3 is an example of a functional block of the processor 11 of the information processing device 1. The processor 11 of the information processing device 1 functionally includes an input data acquisition unit 14, an importance degree calculation unit 15, an attention part identification unit 16, and an output control unit 17. In FIG. 3, the blocks to exchange data are connected to each other by solid line. However, the combinations of blocks to exchange data are not limited as shown in FIG. 3. The same applies to other functional block diagrams to be described later.

The input data acquisition unit 14 acquires the input data Di and supplies the acquired input data Di to the importance degree calculation unit 15 and the output control unit 17. In this case, for example, the input data acquisition unit 14 acquires the video data received from an external device through the interface 13 as the input data Di. In another example, the input data acquisition unit 14 acquires, as the input data Di, the video data specified by the input signal S2 generated based on the user input to the input device 2 from among the video data stored in the storage device 4 or in the memory 12.

The importance degree calculation unit 15 calculates the degree of importance, in time series, of the input data Di based on the input data Di supplied from the input data acquisition unit 14. Then, the importance degree calculation unit 15 supplies information (also referred to as “importance degree information Ii”) indicating the calculated degree of importance in time series to the output control unit 17. In this case, the importance degree calculation unit 15 configures the importance degree inference engine by referring to the importance degree inference engine information D1, and generates the importance degree information Ii obtained by inputting the input data Di to the importance degree inference engine. For example, data (also referred to as “sample data”) that is each section with a predetermined time length obtained by equally dividing the input data Di is inputted to the importance degree inference engine. Here, the importance degree inference engine is a learning model learned to infer, when the sample data is inputted thereto, the degree of importance in the section corresponding to the inputted sample data. In this case, for example, the importance degree calculation unit 15 acquires the degree of importance, in the time series, of the input data Di by sequentially inputting all the sample data, which obtained by dividing the input data Di in section units, to the importance degree inference engine.

In addition, the importance degree calculation unit 15 supplies information (also referred to as “intermediate calculation information Im”) representing the intermediate (midterm) result generated in the process of calculating the degree of importance to the attention part identification unit 16. In this case, for example, the importance degree inference engine has a multi-layer structure with three or more layers, and the importance degree calculation unit 15 supplies the intermediate calculation information Im that is the output value (e.g., the gradient with respect to the output regarding the prediction class) from the intermediate layer(s) of the importance degree inference engine when the sample data described above is inputted to the attention part identification unit 16. In this case, the intermediate calculation information Im may be, for example, map information indicating the attention degree (degree of attention) for each of pixels or for each of sub-pixels of one or more images (frames) constituting the sample data, or may be information indicating the degree of attention of each image for plural images constituting the sample data. It is noted that, for example, the importance degree calculation unit 15 can generate the intermediate calculation information Im described above by using a method according to Grad-CAM or its application technique that is a technique of visualizing the determination basis by the convolutional neural network.

On the basis of the intermediate calculation information Im supplied from the importance degree calculation unit 15, the attention part identification unit 16 identifies the attention part in the input data Di and supplies information (also referred to as “attention part information In”) indicating the identified attention part to the output control unit 17. Details of the process by the attention part identification unit 16 will be described later.

The output control unit 17 generates a display signal S1 for explicitly indicating an attention part based on the input data Di supplied from the input data acquisition unit 14, the importance degree information Ii supplied from the importance degree calculation unit 15, and the attention part information In supplied from the attention part identification unit 16. Then, the output control unit 17 supplies the generated display signal S1 to the display device 3 via the interface 13. The display example by the output control unit 17 will be described later. The output control unit 17 may control, in addition to the display device 3, the sound output device for audio output. For example, the output control unit 17 may output a guidance voice or the like relating to the attention part to the sound output device.

Each component of the input data acquisition unit 14, the importance degree calculation unit 15, the attention part identification unit 16, and the output control unit 17 described in FIG. 3 can be realized by the processor 11 executing a program, for example. In addition, the necessary program may be recorded in any non-volatile storage medium and installed as necessary to realize the respective components. In addition, at least a part of these components is not limited to being realized by a software program and may be realized by any combination of hardware, firmware, and software. At least some of these components may also be implemented using user-programmable integrated circuitry, such as FPGA (Field-Programmable Gate Array) and microcontrollers. In this case, the integrated circuit may be used to realize a program for configuring each of the above-described components. In this way, each component may be implemented by any type of a controller which includes a variety of hardware other than a processor. The above is true for other example embodiments to be described later.

(4) Identification of Attention Part

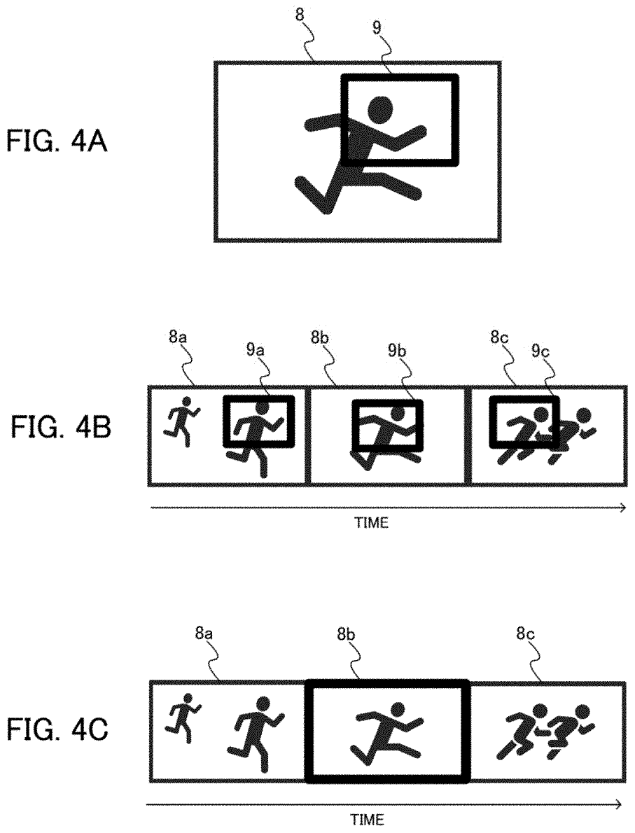

Next, specific examples of the attention part by the attention part identification unit 16 described in FIG. 3 will be described with reference to FIGS. 4A to 4C.

FIG. 4A is a diagram illustrating an attention part in the image identified by the attention part identification unit 16 when the sample data inputted per time to the importance degree inference engine is composed of one image.

In this case, the importance degree calculation unit 15 inputs the image 8 to the importance degree inference engine as the sample data and supplies the intermediate calculation information Im corresponding to the image 8 to the attention part identification unit 16. In this case, for example, the intermediate calculation information Im is map information indicative of the degree of attention for each pixel or for each sub-pixel in the image 8. Then, based on the intermediate calculation information Im supplied from the importance degree calculation unit 15, the attention part identification unit 16 identifies an area of the image 8 surrounded by the frame 9 as an area (also referred to as “attention area”) corresponding to the attention part. Here, the attention part identification unit 16 identifies, as the attention area, a minimum rectangular area surrounding all or more than a predetermined percentage (e.g., 90%) of pixels where the degree of attention according to the above-described map information is equal to or larger than a predetermined threshold value. Instead of identifying a rectangular area as an attention area, the attention part identification unit 16 may identify an area with an arbitrary shape as an attention area. In this case, the attention part identification unit 16 may identifies the area constituted by pixels (partial area) where the degree of attention is equal to or larger than the predetermined threshold value as an attention area as it is.

FIG. 4B is a first example showing an attention part identified by the attention part identification unit 16 when the sample data inputted per time to the importance degree inference engine includes a plurality of images.

In this case, the importance degree calculation unit 15 inputs three images 8a to 8c as sample data to the importance degree inference engine and supplies the intermediate calculation information Im indicating the intermediate calculation result outputted by the importance degree inference engine to the attention part identification unit 16. In this case, the intermediate calculation information Im is, for example, map information indicative of the degree of attention in pixel units or in sub-pixel units for each of the images 8a to 8c. Then, based on the above-described map information supplied from the importance degree calculation unit 15, the attention part identification unit 16 identifies a partial area of the image 8a surrounded by the frame 9a, a partial area of the image 8b surrounded by the frame 9b, and a partial area of the image 8c surrounded by the frame 9c as attention areas corresponding to the attention parts, respectively.

In this way, when there are a plurality of images included in the sample data, the attention part identification unit 16 may identifies, as the attention part, the attention area in each of the images included in the sample data. As in the example shown in FIG. 4A, the attention area is not limited to a rectangular area, and it may be an area with any shape.

FIG. 4C is a second example showing an attention part identified by the attention part identification unit 16 when the sample data inputted per time to the importance degree inference engine is a plurality of images.

In this case, the importance degree calculation unit 15 inputs three images 8a to 8c as sample data to the importance degree inference engine and supplies the intermediate calculation information Im indicating the intermediate calculation result outputted by the importance degree inference engine to the attention part identification unit 16. In this case, the intermediate calculation information Im is the information indicating the degree of attention in image units for each of the images 8a to 8c included in the sample data. Then, the attention part identification unit 16 identifies an image (also referred to as “attention image”) corresponding to the attention part based on the intermediate calculation information Im. In this case, for example, the attention part identification unit 16 identifies the attention part that is an image having the highest degree of attention or one or more images having the degree of attention equal to or higher than a predetermined threshold. In the example shown in FIG. 4C, the attention part identification unit 16 identifies the image 8b as the attention image.

In this way, when there are a plurality of images included in the sample data, the attention part identification unit 16 may identify the attention part in image units.

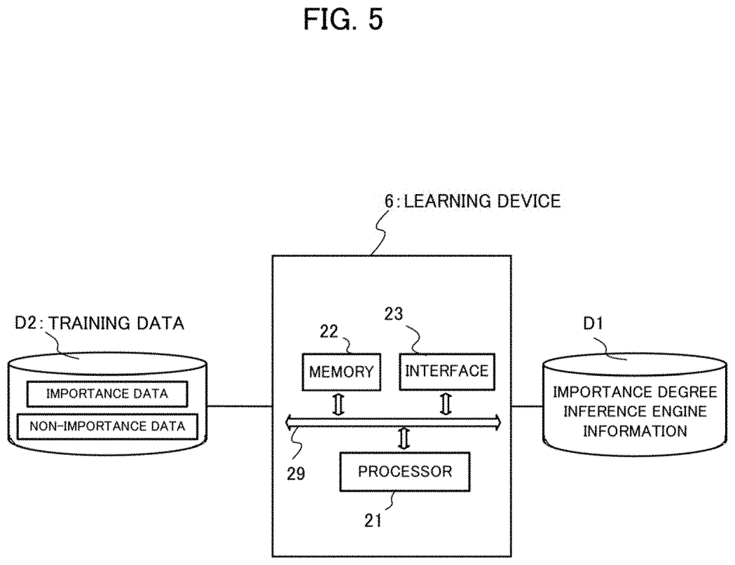

(5) Learning of Importance Degree Inference Engine Next, the generation of the importance degree inference engine information D1 will be described. FIG. 5 is a schematic configuration diagram of a learning system configured to generate the importance degree inference engine information Dl. The learning system includes a learning device 6 configured to refer to the training data D2.

The configuration of the learning device 6 is the same as that of the information processing device 1 illustrated in FIG. 2, for example, and mainly includes a processor 21, a memory 22, and an interface 23. The learning device 6 may be an information processing device 1, or may be any device other than the information processing device 1.

The training data D2 is training datasets that includes plural combinations of video data, which serves as input data to the importance degree inference engine, and a correct answer label indicative of it being important or non-important. The training data D2 contains both of video data (non-importance data) associated with a correct answer label indicative of it being non-important and video data (importance data) associated with a correct answer label indicative of it being important. It is noted that the video data serving as the input data to the importance degree inference engine is data including one or more images.

The learning device 6 learns, by using the training data D2, the importance degree inference engine configured to output, when the video data is inputted thereto, the degree of importance indicated by the corresponding correct answer label. In this case, for example, the learning device 6 may consider the degree of importance to be the lowest value in the case of a correct answer label indicative of it being non-important, and consider the degree of importance to be the maximum value in the case of a correct answer label indicative of it being important.

Then, the learning device 6 determines the parameters of the importance degree inference engine so that the error (loss) between the output from the importance degree inference engine when the video data included in the training data D2 is inputted to the importance degree inference engine and the correct answer label corresponding to the inputted video data is minimized. The algorithm for determining the parameters described above to minimize loss may be any learning algorithm used in machine learning, such as a gradient descent method and an error back-propagation method.

Then, the learning device 6 stores the parameters of the importance degree inference engine obtained by learning as the importance degree inference engine information D1. The generated importance degree inference engine information D1 may be immediately stored in the storage device 4 by data communication between the storage device 4 and the learning device 6, or may be stored in the storage device 4 through a removable storage medium.

(6) Display Examples

Next, a description will be given of display examples of the screen image displayed on the display device 3 under the control of the output control unit 17. Schematically, when any section corresponding to the input data Di is specified, the output control unit 17 displays on the display device 3 the attention part noted in the calculation of the degree of importance corresponding to the specified section in association with the sample data corresponding to the specified section. Accordingly, the output control unit 17 makes the viewer suitably check the information relating to the attention part on the screen image. In this case, the viewer can judge whether or not the importance degree inference engine grasps the correct attention part to calculate the degree of importance, and therefore can evaluate the learning accuracy of the importance degree inference engine. Hereafter, a screen image displayed on the display device 3 under the control of the output control unit 17 is also referred to as “learning accuracy evaluation view”.

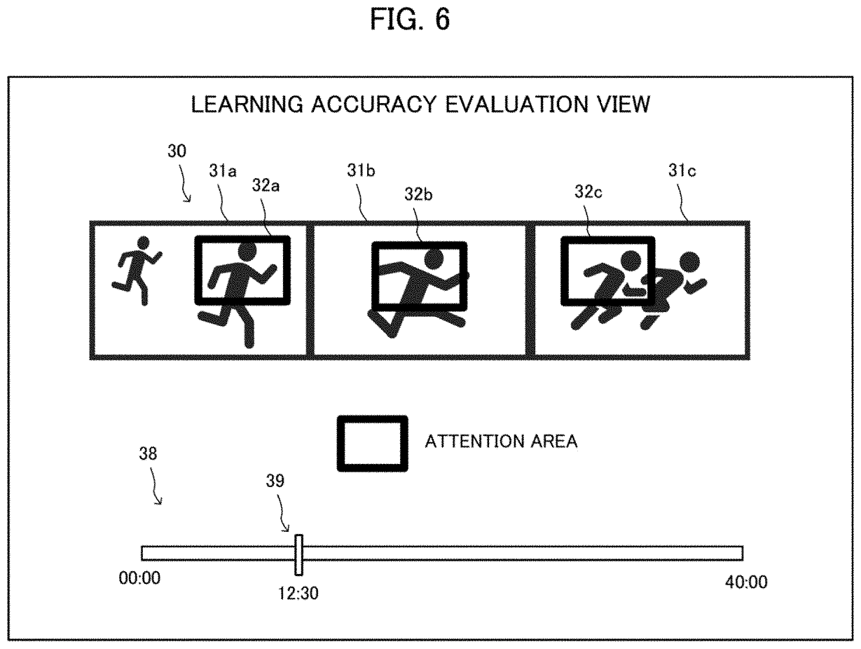

FIG. 6 is a first display example of a learning accuracy evaluation view. In the first display example, the output control unit 17 displays the images of the input data Di corresponding to the section specified by the user side by side and displays the learning accuracy evaluation view that highlights the attention parts in the images on the display device 3. In this case, the output control unit 17 generates the display signal Si based on the input data Di, the importance degree information Ii, and the attention part information In, and supplies the generated display signal S1 to the display device 3, thereby causing the display device 3 to display the learning accuracy evaluation view.

The output control unit 17 provides, on the learning accuracy evaluation view according to the first display example, an attention part display area 30 for displaying sample data and an attention part corresponding to a section specified by the user, and a seek bar 38 for specifying a section in which attention parts are visualized.

Here, the seek bar 38 is a bar that clearly indicates the playback time length (40 minutes in this case) of the input data Di, and there provided a slide 39 for specifying a target section (in this case, a section corresponding to 12 minutes 30 seconds) of visualization of the attention parts. Here, the output control unit 17 moves the slide 39 on the seek bar 38 to a position specified by the user based on the input signal S2 generated by the input device 2.

The output control unit 17 extracts the sample data corresponding to the section specified by the slide 39 from the input data Di, and displays the corresponding attention parts on the attention part display area 30 in association with the images included in the extracted sample data. In the example shown in FIG. 6, the output control unit 17 displays the images 31a to 31c included in the sample data corresponding to the section at 12:30 side by side, and displays a rectangular frames 32a to 32c each indicating the attention area for each image on the images 31a to 31c.

As described above, in the first display example, the output control unit 17 can suitably present, to the viewer, attention parts identified by the attention part identification unit 16 for the sample data corresponding to the section specified by the user. This makes it possible for the viewer to confirm whether or not the importance degree inference engine grasps the correct attention parts to calculate the degree of importance, and to evaluate the learning accuracy of the importance degree inference engine. When the sample data is configured by a single image, the output control unit 17 displays the learning accuracy evaluation view for displaying the partial area serving as an attention part in the image in the same manner as in FIG. 4A on the display device 3. The output control unit 17 may further display the degree of importance calculated for the section specified by the user on the learning accuracy evaluation view.

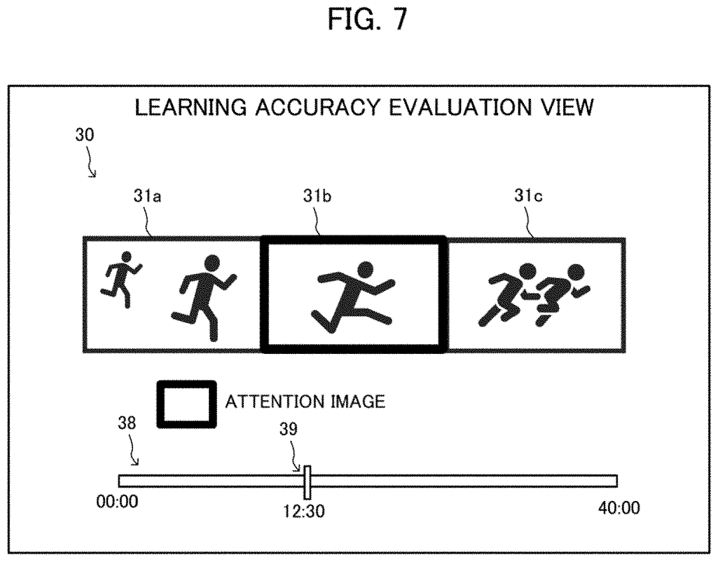

FIG. 7 is a second display example of the learning accuracy evaluation view. In the second display example, the output control unit 17 displays images included in the input data Di corresponding to the sections specified by the user side by side and displays the learning accuracy evaluation view which highlights the attention image selected from the images on the display device 3. The output control unit 17 provides, on the learning accuracy evaluation view according to the second display example, the attention part display area 30 and the seek bar 38 as in the first display example.

In the second display example, the attention part identification unit 16 identifies the attention image for each sample data as the attention part, and supplies the attention part information In indicating the attention image to the output control unit 17. Then, the output control unit 17 extracts the sample data corresponding to the section specified by the seek bar 38 from the input data Di, and displays the images 31a to 31c included in the extracted sample data on the attention part display area 30. In this case, the output control unit 17 highlights the image 31b specified as the attention image by the edging effect on the basis of the attention part information In.

As described above, in the second display example, the output control unit 17 presents, to the viewer, the attention image specified by the attention part identification unit 16 for the sample data corresponding to the section specified by the user, and suitably causes the viewer to perform the evaluation of the learning accuracy of the importance degree inference engine. The output control unit 17 may specify the degree of attention of each image (images 31a to 31c in FIG. 7) included in the sample data based on the intermediate calculation information Im and further display the degree of attention of each specified image in association with the each specified image.

(7) Process Flow

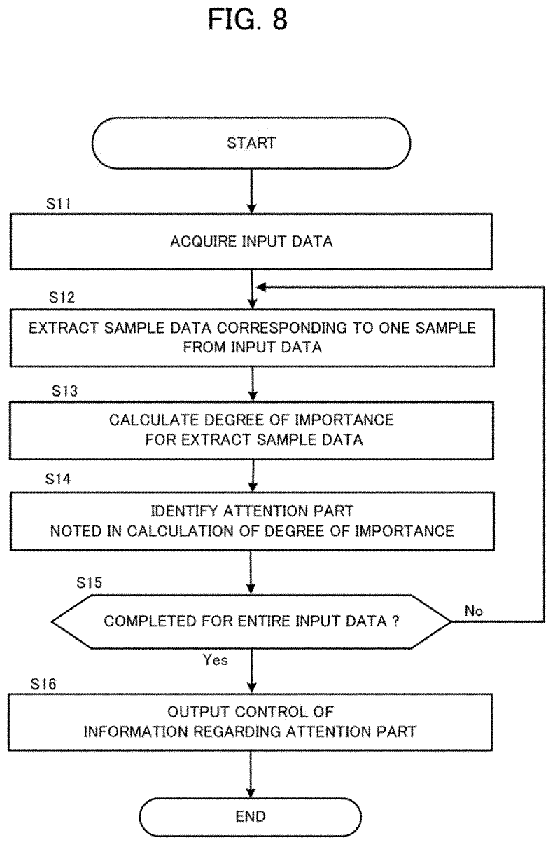

FIG. 8 is an example of a flowchart illustrating a procedure of the attention part visualization process performed by the information processing device 1 in the first example embodiment. The information processing device 1 executes the processing of the flowchart shown in FIG. 8, for example, when a user input for specifying the input data Di is detected or when the input data Di is received from an external device.

First, the input data acquisition unit 14 of the information processing device 1 acquires the input data Di (step S11). Next, the importance degree calculation unit 15 of the information processing device 1 extracts sample data, which is data for one sample that can be inputted to the importance degree inference engine, from the input data Di (step S12). In this case, for example, the importance degree calculation unit 15 extracts the sample data corresponding to the unextracted section in the input data Di in order from the section where the playback time is earlier.

Then, the importance degree calculation unit 15 calculates the degree of importance for the sampled data extracted at step S12 (step S13). In this case, the importance degree calculation unit 15 configures the importance degree inference engine by referring to the importance degree inference engine information D1, and inputs the above-described sample data into the importance degree inference engine to calculate the degree of importance.

Further, the attention part identification unit 16 of the information processing device 1 identifies the attention part noted in the calculation of the degree of importance for the sample data extracted at step S12 (step S14). In this case, based on the intermediate calculation information Im supplied from the importance degree calculation unit 15, the attention part identification unit 16 identifies the attention area in each image included in the sample data or the attention image among the images included in the sample data as the attention part.

Next, the information processing device 1 determines whether or not the processes at step S12 to step S14 have been completed for the entire input data Di (step S15). If the information processing device 1 determines that the processes at step S12 to step S14 have not been completed for the entire input data Di yet (step S15; No), the information processing device 1 gets back to the process at step S12. In this case, the information processing device 1 executes the processes at step S12 to step S14 on the sample data corresponding to an unextracted section of the input data Di.

On the other hand, if the information processing device 1 determines that the processes at step S12 to step S14 have been completed for the entire input data Di (step S15; Yes), the output control unit 17 of the information processing device 1 performs output control of the information relating to the attention part (step S16). In this case, based on the input data Di supplied from the input data acquisition unit 14, the importance degree information Ii supplied from the importance degree calculation unit 15, and the attention part information In supplied from the attention part identification unit 16, the output control unit 17 generates the display signal S1 relating to the learning accuracy evaluation view exemplified in FIGS. 6 and 7 and supplies the display signal S1 to the display device 3.

(8) Modifications

Next, a description will be given of each modification suitable for the above example embodiment. The following modifications may be applied to the example embodiments described above in arbitrary combination.

(First Modification)

When detecting a user input that specifies information regarding the correctness of an attention part on the learning accuracy evaluation view, the information processing device 1 may perform the training (learning) of the importance degree inference engine based on the information regarding the correctness specified by the user input.

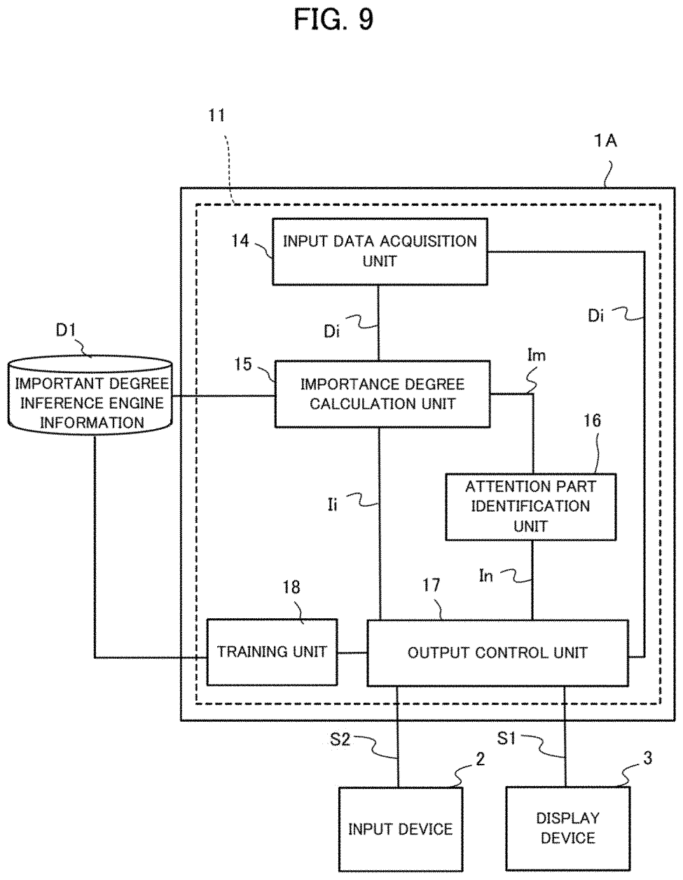

FIG. 9 shows an exemplary functional block diagram of the processor 11 of the information processing device 1A according to the present modification. The processor 11 according to this modification includes an input data acquisition unit 14, an importance degree calculation unit 15, an attention part identification unit 16, an output control unit 17, and a training unit 18. The common reference numerals are assigned to the same elements in FIG. 9 as the elements of the information processing device 1 shown in FIG. 3, and the description thereof will be omitted hereinafter.

The training (learning) unit 18 updates the importance degree inference engine information D1 by performing the training of the importance degree inference engine based on the input signal S2 that specifies the correctness of an attention part or a correct attention part on the learning accuracy evaluation view. For example, when the training unit 18 detects that the correctness of the attention part indicated on the learning accuracy evaluation view is specified based on the input signal S2, the training unit 18 trains the importance degree inference engine configured to output the intermediate calculation information Im based on the presented sample data and attention part and the specified correctness. For example, when the input signal S2 indicates that the attention part is correct, the training unit 18 trains the importance degree inference engine by using the combination of the sample data and the attention part indicated on the learning accuracy evaluation view as a positive example. Further, when a correct attention part is specified by the user input on the learning accuracy evaluation view, the training unit 18 performs the training of the importance degree inference engine configured to output the intermediate calculation information Im using the combination of the sample data inputted to the importance degree inference engine and the attention part specified by the user input.

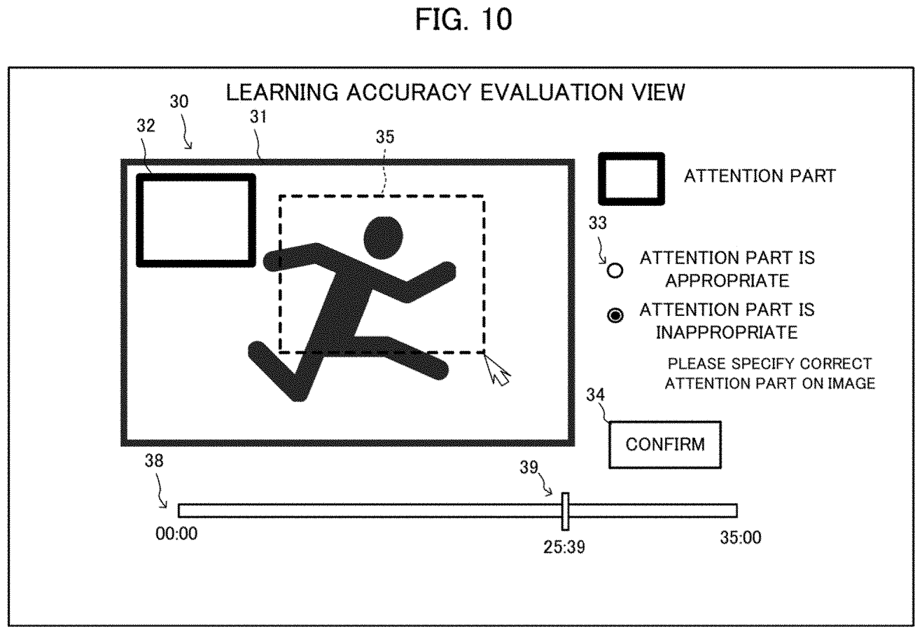

FIG. 10 shows a third display example of the learning accuracy evaluation view. In the third display example, the output control unit 17 displays a learning accuracy evaluation view in which the attention part is associated with the sample data on the display device 3, wherein the learning accuracy evaluation view accepts an input relating to the designation of the correctness of the displayed attention part and a further input of the correct attention area in the case where the identified attention area is incorrect. As an example, in the third display example, the sample data is assumed to be configured by a single image.

In this case, the output control unit 17 extracts the sample data corresponding to the section (here, the section corresponding to 25 minutes and 39 seconds) specified by the seek bar 38 from the input data Di, and displays the image 31 which is the extracted sample data on the attention part display area 30 together with the rectangular frame 32 indicating the attention area. Further, on the learning accuracy evaluation view, the output control unit 17 displays a radio button 33 which is a button for selecting whether the attention part (here, the attention area) presented on the attention part display area 30 is appropriate or inappropriate.

Furthermore, when the attention area is inappropriate, the output control unit 17 displays a message indicating that the attention area to be the correct solution should be specified on the image, and accepts the designation of the attention area to be the correct solution on the image 31. In the example shown in FIG. 10, the output control unit 17 displays a rectangular frame 35 of a broken line specified by the drag-and-drop operation of the pointer on the image 31.

When the confirm button 34 is selected, the output control unit 17 supplies information relating to the selection result of the radio button 33 and the designation of the position of the rectangular frame 35 on the image 31 to the training unit 18. Then, based on the information supplied from the output control unit 17, the training unit 18 performs the training of the importance degree inference engine configured to output the intermediate calculation information Im which was used for determining the attention part.

Thus, according to this modification, it is also possible to improve the accuracy of the importance degree inference engine by accepting feedback by the user. When the attention image is presented on the attention part display area 30, the information processing device 1A receives a user input that specifies the correct attention image from a plurality of images serving as sample data on the learning accuracy evaluation view.

(Second Modification)

When audio data is included in the input data Di, the information processing device 1 may calculate the degree of importance in consideration of the audio data and identify the attention part in calculation of the degree of importance.

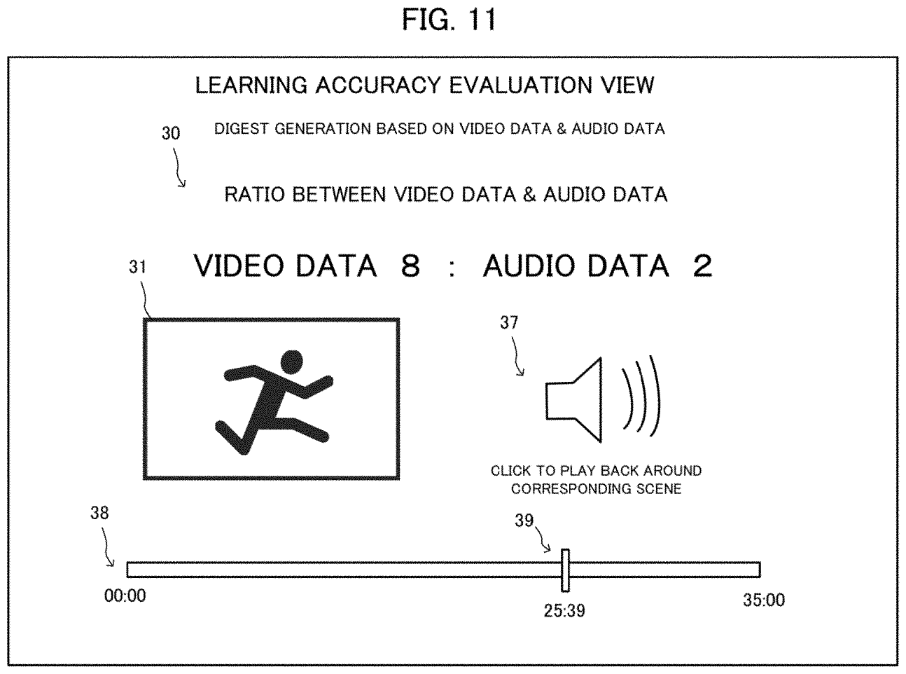

FIG. 11 shows a fourth display example of the learning accuracy evaluation view. In the fourth display example, the input data Di includes both the video data and the audio data, and the importance degree calculation unit 15 calculates the degree of importance based on both the video data and the audio data. In this case, the importance degree inference engine is learned to accept the input data that is the sample data including the video data and the audio data and then infer the degree of importance of the inputted sample data.

The output control unit 17 displays the image 31 corresponding to the section specified by the seek bar 38 on the attention part display area 30 and displays a sound playback icon 37 for playing back the audio data corresponding to the image 31. Here, as an example, it is assumed that one sample data includes one image as in the third display example of the learning accuracy evaluation view. Further, the output control unit 17, when detecting that the sound playback icon 37 is selected, it performs playback of audio data corresponding to the sample data.

Further, on the attention part display area 30, the output control unit 17 clearly indicates each degree of attention of the video data (here, the image) and the audio data in the calculation of the degree of importance. In this case, for example, the importance degree calculation unit 15 supplies the intermediate calculation information Im indicating at least the respective degrees of attention of the video data and the audio data to the attention part identification unit 16.

Then, based on the intermediate calculation information Im supplied from the importance degree calculation unit 15, the attention part identification unit 16 supplies the attention part information In that indicates at least the ratio between the degree of attention of the video data and the degree of attention of the audio data to the output control unit 17. Then, the output control unit 17 recognizes the ratio between the degree of attention of the video data and the degree of attention of the audio data (here, 8:2) in the calculation of the degree of importance based on the attention part information In, and displays the ratio on the attention part information In as the degree of attention for each of the video data and the audio data.

In the case where the sample data includes a plurality of images, the output control unit 17 may display the plurality of images side by side on the attention part display area 30, and displays the degrees of attention of the video data including the plurality of images and the audio data, respectively.

Accordingly, the information processing device 1 according to the second modification can suitably visualize the attention part in the calculation of the degree of importance even when the degree of importance is calculated based on both the video data and the audio data.

(Third Modification)

The information processing device 1 may calculate the degree of importance of the input data Di based only on the audio data. In this case, the information processing device 1 may identify the attention part in the audio data and display the information regarding the attention part.

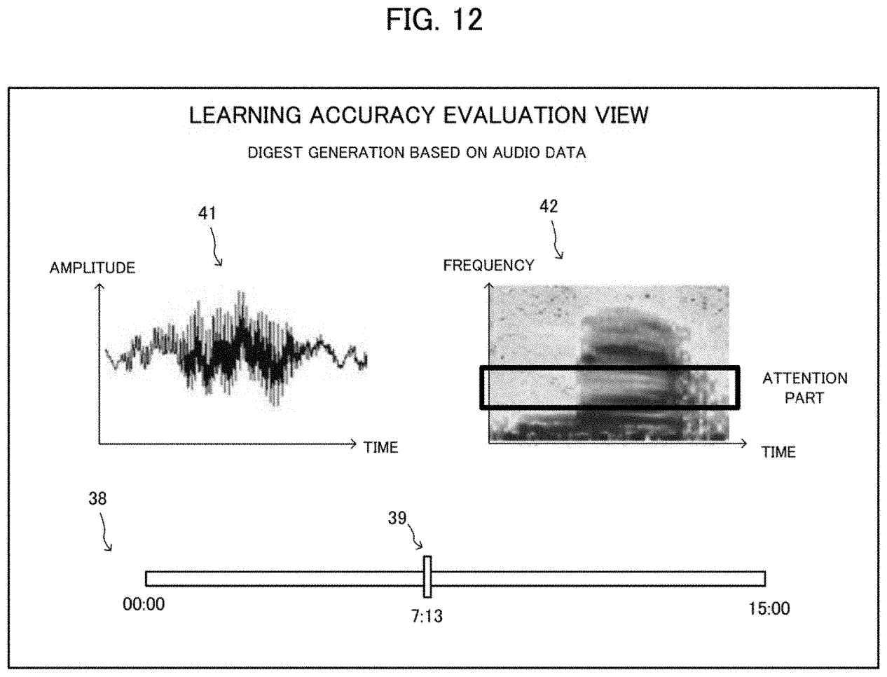

FIG. 12 shows a fifth display example of a learning accuracy evaluation view. The learning accuracy evaluation view according to the fifth display example is a screen image for evaluating the learning accuracy of the importance degree inference engine configured to calculate the degree of importance in the digest generation based on audio data, and includes a seeker 38, an audio waveform display area 41, and an audio spectrogram display area 42.

In this case, the output control unit 176 extracts from the input data Di the sample data which is configured by audio data and which corresponds to the section (here, 7 minutes 13 seconds) specified by the seek bar 38. Then, the output control unit 17 displays the waveform of the extracted audio data in the sound waveform display area 41, and displays an image corresponding to the calculation result of the frequency spectrum of the audio data in the sound spectrogram display area 42.

Further, the output control unit 17 identifies the frequency region corresponding to the attention part based on the attention part information In supplied from the attention part identification unit 16 and highlights the specified frequency region on the sound spectrogram display region 42. Here, as an example, the importance degree calculation unit 15 supplies the intermediate calculation information Im indicating the degree of attention for each frequency to the attention part identification unit 16. Then, on the basis of the intermediate calculation information Im, the attention part identification unit 16 identifies the attention part that is the frequency region where the degree of attention is higher than a threshold, and supplies the attention part information In indicating the identified frequency region to the output control unit 17. Instead of identifying the attention part that is a frequency region in the sample data, the attention part identification unit 16 may identify the attention part that is a section (sub-section) having a particularly high degree of attention in the section corresponding to the sample data. In this case, the output control unit 17 may highlight the sub-section indicated by the attention part information In supplied from the attention part identification unit 16 on the audio waveform display area 41 or on the audio spectrogram display area 42.

Thus, the information processing device 1, even when calculating, based on the audio data, the degree of importance that is an index necessary for digest generation, it is possible to suitably visualize the attention part in the calculation of the degree of importance.

(Fourth Modification)

The attention part visualization system 100 may be a client-server model.

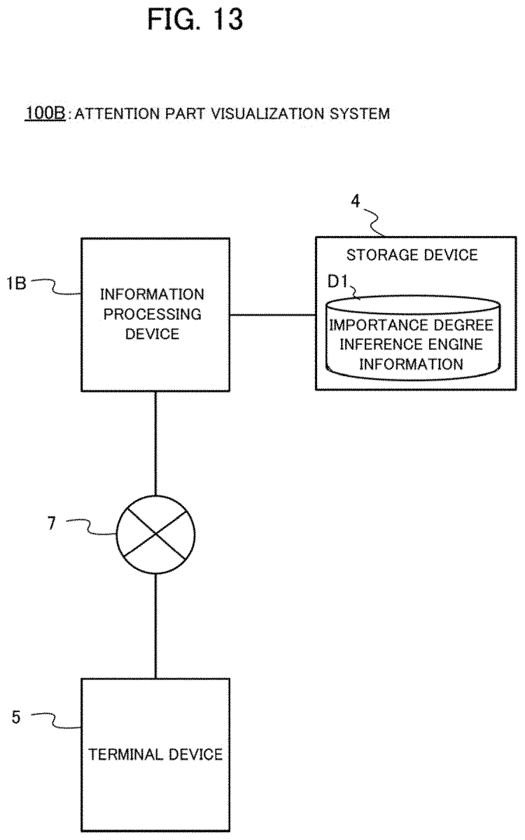

FIG. 13 shows the configuration of an attention part visualization system 100B in the fourth modification. As illustrated in FIG. 13, the attention part visualization system 100B mainly includes an information processing device 1B that functions as a server, a storage device 4 that stores information required for the attention part visualization, and a terminal device 5 that functions as a client. The information processing device 1B and the terminal device 5 perform data communication via the network 7.

The terminal device 5 is a terminal equipped with an input function, a display function, and a communication function, and functions as the input device 2 and the display device 3 shown in FIG. 1. Examples of the terminal device 5 include a personal computer, a tablet-type terminal, and a PDA (Personal Digital Assistant). The terminal device 5 transmits information based on a user input and the like to the information processing device 1A.

The information processing device 1A has the same configuration as the information processing device 1 illustrated in FIG. 1 and executes the attention part visualization process illustrated in FIG. 8. Here, in the output control at step S16, the information processing device 1A transmits a display signal indicating information relating to the attention part to the terminal device 5 via the network 7. Thereby, the information processing device 1A can suitably present information on the attention part in the calculation of the degree of importance to the viewer of the terminal device 5.

<Second Example Embodiment>

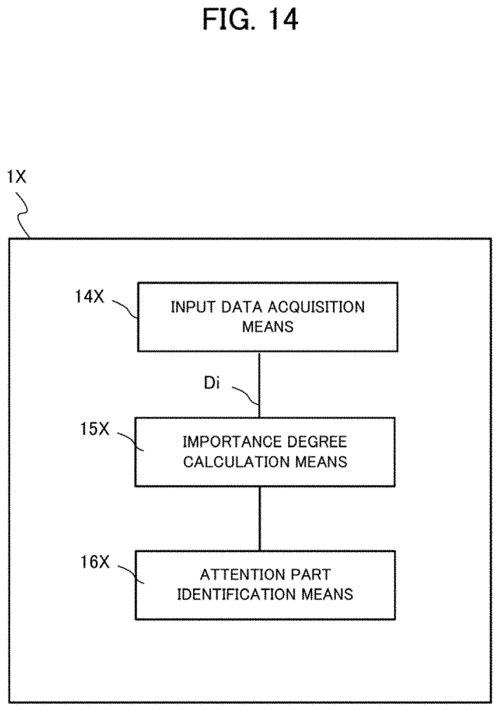

FIG. 14 is a functional block diagram of the information processing device 1X according to the second example embodiment. The information processing device 1X mainly includes an input data acquisition means 14X, an importance degree calculation means 15X, and an attention part identification means 16X.

The input data acquisition means 14X is configured to acquire input data “Di” including at least one of video data or audio data. The video data is data including at least one image. Examples of the input data acquisition means 14X include the input data acquisition unit 14 in the first example embodiment.

The importance degree calculation means 15X is configured to calculate a degree of importance of the input data Di. In this case, the importance degree calculation means 15X may equally divide the input data Di into each section with a predetermined time length and calculate the importance for each section. In this case, the importance degree calculation means 15X calculates the time-series degrees of importance of the input data Di. Examples of the importance degree calculation means 15X include the importance degree calculation unit 15 in the first example embodiment.

The attention part identification means 16X is configured to identify an attention part of the input data Di in a calculation of the degree of importance. It is noted that in a case where the importance degree calculation means 15X calculates the time-series degrees of importance of the input data Di, the attention part identification means 16X may identify an attention part corresponding to at least one of the time-series degrees of importance. Examples of the attention part identification means 16X include the attention part identification unit 16 in the first example embodiment.

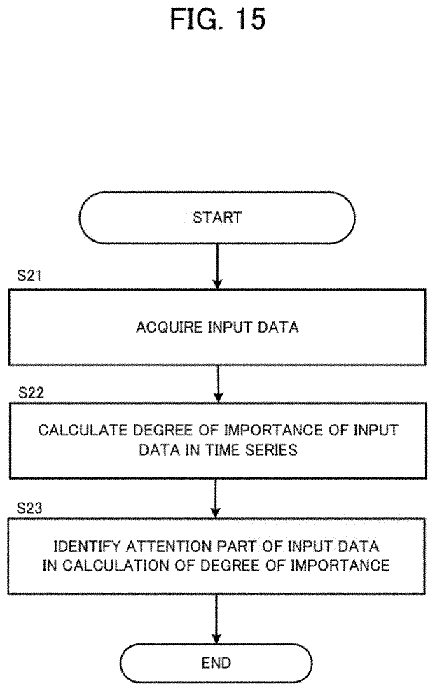

FIG. 15 is an example of a flowchart executed by the information processing device 1X in the second example embodiment. First, the input data acquisition means 14X acquires input data “Di” including at least one of video data or audio data (step S21). The importance degree calculation means 15X calculates a degree of importance of the input data Di (step S22). The attention part identification means 16X identifies an attention part of the input data Di in a calculation of the degree of importance (step S23).

The information processing device 1X according to the second example embodiment can suitably identify the attention part in the calculation of the degree of importance for the input data including at least one of the video data or the audio data.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments described above (including modifications, the same applies hereinafter) can be described as, but not limited to, the following Supplementary Notes.

[Supplementary Note 1]

An information processing device comprising:

an input data acquisition means configured to acquire input data including at least one of video data or audio data;

an importance degree calculation means configured to calculate a degree of importance of the input data; and

an attention part identification means configured to identify an attention part of the input data in a calculation of the degree of importance.

[Supplementary Note 2]

The information processing device according to Supplementary Note 1,

wherein the importance degree calculation means is configured to calculate the degree of importance of the input data based on an inference engine learned to infer, when data including at least one of video data or audio data is inputted thereto, the degree of importance of the inputted data.

[Supplementary Note 3]

The information processing device according to Supplementary Note 2,

wherein the inference engine has a multi-layer structure, and

wherein the attention part identification means is configured to identify the attention part based on an output from an intermediate layer of the inference engine.

[Supplementary Note 4]

The information processing device according to any one of Supplementary Notes 1 to 3,

wherein the input data includes the video data, and

wherein the attention part identification means is configured to identify, as the attention part, an attention area noted in the calculation of the degree of importance in an image included in the video data.

[Supplementary Note 5]

The information processing device according to any one of Supplementary Notes 1 to 3,

wherein the input data includes the video data, and

wherein the attention part identification means is configured to select, as the attention part, an attention image noted in the calculation of the degree of importance from images included in the video data.

[Supplementary Note 6]

The information processing device according to any one of Supplementary Notes 1 to 3,

wherein the input data includes the audio data, and

wherein the attention part identification means is configured to identify, as the attention part, a section or a frequency of the audio data noted in the calculation of the degree of importance.

[Supplementary Note 7]

The information processing device according to any one of Supplementary Notes 1 to 6,

wherein the input data includes both the video data and the audio data, and

wherein the attention part identification means is configured to identify each degree of attention of the video data and the audio data in the calculation of the importance degree.

[Supplementary Note 8]

The information processing device according to any one of Supplementary Notes 1 to 7, further comprising

an output control means configured to display information relating to the attention part on a display device.

[Supplementary Note 9]

The information processing device according to Supplementary Note 8,

wherein, when a section corresponding to the input data is specified, the output control unit is configured to display, on the display device, the attention point noted in the calculation of the degree of importance corresponding to the specified section in association with the input data corresponding to the section.

[Supplementary Note 10]

The information processing device according to any one of Supplementary Notes 1 to 9, further comprising

a training means configured to train, when there is a user input specifying information on correctness of the attention part, an inference engine used for calculating the degree of importance based on the information on the correctness.

[Supplementary Note 11]

The information processing device according to any one of Supplementary Notes 1 to 10,

wherein the degree of importance is an index that serves as a criterion in generating a digest of the input data.

[Supplementary Note 12]

A control method executed by a computer, the control method comprising:

acquiring input data including at least one of video data or audio data;

calculating a degree of importance of the input data; and

identifying an attention part of the input data in a calculation of the degree of importance.

[Supplementary Note 13]

A storage medium storing a program executed by a computer, the program causing the computer to function as:

an input data acquisition means configured to acquire input data including at least one of video data or audio data;

an importance degree calculation means configured to calculate a degree of importance of the input data; and

an attention part identification means configured to identify an attention part of the input data in a calculation of the degree of importance.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1, 1A, 1B, 1X Information processing device

2 Input device

3 Display device

4 Storage device

5 Terminal device

6 Learning device

100, 100B attention part visualization system

What is claimed is:

1. An information processing device comprising:
at least one memory configured to store instructions; and
at least one processor configured to execute the instructions to acquire input data including at least one of video data or audio data;
calculate a degree of importance of the input data; and
identify an attention part of the input data in a calculation of the degree of importance.

2. The information processing device according to claim 1,
wherein the at least one processor is configured to execute the instructions to calculate the degree of importance of the input data based on an inference engine learned to infer, when data including at least one of video data or audio data is inputted thereto, the degree of importance of the inputted data.

3. The information processing device according to claim 2,
wherein the inference engine has a multi-layer structure, and
wherein the at least one processor is configured to execute the instructions to identify the attention part based on an output from an intermediate layer of the inference engine.

4. The information processing device according to claim 1
wherein the input data includes the video data, and
wherein the at least one processor is configured to execute the instructions to identify, as the attention part, an attention area noted in the calculation of the degree of importance in an image included in the video data.

5. The information processing device according to claim 1,
wherein the input data includes the video data, and
wherein the at least one processor is configured to execute the instructions to select, as the attention part, an attention image noted in the calculation of the degree of importance from images included in the video data.

6. The information processing device according to claim 1,
wherein the input data includes the audio data, and
wherein the at least one processor is configured to execute the instructions to identify, as the attention part, a section or a frequency of the audio data noted in the calculation of the degree of importance.

7. The information processing device according to claim 1,
wherein the input data includes both the video data and the audio data, and
wherein the at least one processor is configured to execute the instructions to identify each degree of attention of the video data and the audio data in the calculation of the importance degree.

8. The information processing device according to comprising claim 1,
wherein the at least one processor is configured to further execute the instructions to display information relating to the attention part on a display device.

9. The information processing device according to claim 8,
wherein, when a section corresponding to the input data is specified, the at least one processor is configured to execute the instructions to display, on the display device, the attention point noted in the calculation of the degree of importance corresponding to the specified section in association with the input data corresponding to the section.

10. The information processing device according to claim 1,
wherein the at least one processor is configured to further execute the instructions to train, when there is a user input specifying information on correctness of the attention part, an inference engine used for calculating the degree of importance based on the information on the correctness.

11. The information processing device according to claim 1,
wherein the degree of importance is an index that serves as a criterion in generating a digest of the input data.

12. A control method executed by a computer, the control method comprising:
acquiring input data including at least one of video data or audio data;
calculating a degree of importance of the input data; and
identifying an attention part of the input data in a calculation of the degree of importance.

13. A non-transitory computer readable storage medium storing a program executed by a computer, the program causing the computer to:
acquire input data including at least one of video data or audio data;
calculate a degree of importance of the input data; and
identify an attention part of the input data in a calculation of the degree of importance.
